(19) United States
(12) Patent Application Publication
(10) Pub. No.: US 2023/0029330 A1
(43) Pub. Date: Jan. 26, 2023

(54) METHOD AND SYSTEM FOR GAMIFICATION OF AGGREGATED DATA

(71) Applicant: JPMorgan Chase Bank, N.A., New York, NY (US)

(72) Inventors: Stacy Newman KANDEL, Easton, PA (US); Tanya MORRIS, New York, NY (US); Kamesh KARRA, Jersey City, NJ (US); Thenmozhi MUTHUSAMY, Short Hills, NJ (US); Anupam JAIN, Jersey City, NJ (US); Kathan CHEEMA, Glasgow (GB); Kamal PATEL, Edinburgh (GB); Yoganandam MARAVA, Glasgow (GB); Prashant CHAUHAN, Edison, NJ (US); Stella LAM, Jersey City, NJ (US)

(73) Assignee: JPMorgan Chase Bank, N.A., New York, NY (US)

(21) Appl. No.: 17/809,341

(22) Filed: Jun. 28, 2022

Related U.S. Application Data
(60) Provisional application No. 63/203,421, filed on Jul. 22, 2021.

(51) Int. Cl. G06Q 10/06; G06F 16/21; G06F 16/2457

(52) U.S. Cl. CPC G06Q 10/06393; G06Q 10/06398; G06F 16/219; G06F 16/2457

(57) ABSTRACT

A method for aggregating data to facilitate gamification of employee contributions is provided. The method includes compiling, via an application programming interface, raw data from a source, the raw data including employee contribution data, employee achievement data, and employee engagement data; mapping the compiled raw data based on a predetermined guideline; generating a structured data set based on a result of the mapping; identifying a user record from the structured data set; determining a characteristic for the identified user record; and updating a user profile that corresponds to the identified user record with information relating to the determined characteristic.

### CROSS-REFERENCE TO RELATED APPLICATIONS

This application claims the benefit of U.S. Provisional Patent Application Ser. No. 63/203,421, filed Jul. 22, 2021, which is hereby incorporated by reference in its entirety.

### BACKGROUND

### 1. Field of the Disclosure

This technology generally relates to methods and systems for gamification, and more particularly to methods and systems for aggregating data from a variety of sources to facilitate gamification of employee contributions and incentivize employee engagement.

### 2. Background Information

Many business entities encourage employee involvement in worthwhile causes such as, for example, diversity and inclusion initiatives to foster a healthy workforce. These initiatives may be operated by the business entities, affiliated entities, as well as third-party entities. Historically, implementation of traditional techniques for managing contributions from each individual employee have resulted in varying degrees of success with respect to efficient tracking of the contributions and effective encouragement of the employees.

One drawback of using traditional techniques for managing employee contributions is that in many instances, each of the initiatives operate independently and use different data schemas. As a result, tracking and managing employee contributions across the different data schemas are burdensome and often not possible in certain circumstances. In addition, the employee contribution data that are effectively tracked are not usable to encourage further contributions from the employees.

Therefore, there is a need for an integrated employee contribution platform that aggregates data from a variety of sources to facilitate gamification of employee contributions and incentivize employee engagement.

### SUMMARY

The present disclosure, through one or more of its various aspects, embodiments, and/or specific features or sub-components, provides, inter alia, various systems, servers, devices, methods, media, programs, and platforms for aggregating data from a variety of sources to facilitate gamification of employee contributions and incentivize employee engagement.

According to an aspect of the present disclosure, a method for aggregating data to facilitate gamification of employee contributions is provided. The method is implemented by at least one processor. The method may include compiling, via an application programming interface, raw data from at least one source, the raw data may include at least one from among employee contribution data, employee achievement data, and employee engagement data; mapping the compiled raw data based on at least one predetermined guideline; generating at least one structured data set based on a result of the mapping; identifying at least one user record from the at least one structured data set; determining at least one characteristic for each of the at least one identified user record; and updating a user profile that corresponds to the identified at least one user record with information relating to the determined at least one characteristic.

In accordance with an exemplary embodiment, the at least one characteristic may include at least one from among a first score that corresponds to an employee contribution, a second score that corresponds to an employee achievement, and a third score that corresponds to an employee engagement.

In accordance with an exemplary embodiment, the user profile may include at least one from among a social media profile that is accessible via a social media platform and an employee profile that is accessible via an enterprise communication platform.

In accordance with an exemplary embodiment, the method may further include generating at least one graphical element for each of the at least one characteristic, the at least one graphical element may include a visual representation of the at least one characteristic that is configured to receive an input; and displaying, via a graphical user interface, the user profile together with the corresponding at least one graphical element.

In accordance with an exemplary embodiment, the at least one graphical element may be generated when the corresponding at least one characteristic satisfies at least one predetermined threshold.

In accordance with an exemplary embodiment, the visual representation may include at least one from among a badge, a performance graph, and a leaderboard.

In accordance with an exemplary embodiment, the method may further include identifying at least one updated characteristic for each of the at least one identified user record; determining a comparative difference between the at least one updated characteristic and the at least one characteristic; and regenerating the at least one graphical element based on the comparative difference, the regenerated at least one graphical element may illustrate the comparative difference.

In accordance with an exemplary embodiment, the illustration of the comparative difference may include at least one from among an enlargement of the at least one graphical element for a positive change and diminution of the at least one graphical element for a negative change.

In accordance with an exemplary embodiment, the method may further include detecting at least one error, the error may relate to a corruption of at least one from among the at least one structured data set and the at least one user record; automatically initiating at least one recovery action for the at least one error, the at least one recovery action may relate to replacement of corrupted data with corresponding historical data; and documenting the at least one error and the corresponding at least one recovery action.

According to an aspect of the present disclosure, a computing device configured to implement an execution of a method for aggregating data to facilitate gamification of employee contributions is disclosed. The computing device including a processor; a memory; and a communication interface coupled to each of the processor and the memory, wherein the processor may be configured to compile, via an application programming interface, raw data from at least one source, the raw data may include at least one from among employee contribution data, employee achievement data, and employee engagement data; map the compiled raw data based on at least one predetermined guideline; generate at least one structured data set based on a result of the mapping; identify at least one user record from the at least one structured data set; determine at least one characteristic for each of the at least one identified user record; and update a user profile that corresponds to the identified at least one user record with information relating to the determined at least one characteristic.

In accordance with an exemplary embodiment, the at least one characteristic may include at least one from among a first score that corresponds to an employee contribution, a second score that corresponds to an employee achievement, and a third score that corresponds to an employee engagement.

In accordance with an exemplary embodiment, the user profile may include at least one from among a social media profile that is accessible via a social media platform and an employee profile that is accessible via an enterprise communication platform.

In accordance with an exemplary embodiment, the processor may be further configured to generate at least one graphical element for each of the at least one characteristic, the at least one graphical element may include a visual representation of the at least one characteristic that is configured to receive an input; and display, via a graphical user interface, the user profile together with the corresponding at least one graphical element.

In accordance with an exemplary embodiment, the processor may be further configured to generate the at least one graphical element when the corresponding at least one characteristic satisfies at least one predetermined threshold.

In accordance with an exemplary embodiment, the visual representation may include at least one from among a badge, a performance graph, and a leaderboard.

In accordance with an exemplary embodiment, the processor may be further configured to identify at least one updated characteristic for each of the at least one identified user record; determine a comparative difference between the at least one updated characteristic and the at least one characteristic; and regenerate the at least one graphical element based on the comparative difference, the regenerated at least one graphical element may illustrate the comparative difference.

In accordance with an exemplary embodiment, the illustration of the comparative difference may include at least one from among an enlargement of the at least one graphical element for a positive change and diminution of the at least one graphical element for a negative change.

In accordance with an exemplary embodiment, the processor may be further configured to detect at least one error, the error may relate to a corruption of at least one from among the at least one structured data set and the at least one user record; automatically initiate at least one recovery action for the at least one error, the at least one recovery action may relate to replacement of corrupted data with corresponding historical data; and document the at least one error and the corresponding at least one recovery action.

According to an aspect of the present disclosure, a non-transitory computer readable storage medium storing instructions for aggregating data to facilitate gamification of employee contributions is disclosed. The storage medium including executable code which, when executed by a processor, may cause the processor to compile, via an application programming interface, raw data from at least one source, the raw data may include at least one from among employee contribution data, employee achievement data, and employee engagement data; map the compiled raw data based on at least one predetermined guideline; generate at least one structured data set based on a result of the mapping; identify at least one user record from the at least one structured data set; determine at least one characteristic for each of the at least one identified user record; and update a user profile that corresponds to the identified at least one user record with information relating to the determined at least one characteristic.

In accordance with an exemplary embodiment, the at least one characteristic may include at least one from among a first score that corresponds to an employee contribution, a second score that corresponds to an employee achievement, and a third score that corresponds to an employee engagement.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for aggregating data from a variety of sources to facilitate gamification of employee contributions and incentivize employee engagement.

FIG. 4 is a flowchart of an exemplary process for implementing a method for aggregating data from a variety of sources to facilitate gamification of employee contributions and incentivize employee engagement.

FIG. 5 is a context diagram of an exemplary process for implementing a method for aggregating data from a variety of sources to facilitate gamification of employee contributions and incentivize employee engagement.

FIG. 6 is a container diagram of an exemplary process for implementing a method for aggregating data from a variety of sources to facilitate gamification of employee contributions and incentivize employee engagement.

FIG. 7 is an overview diagram of an exemplary architecture for implementing a method for aggregating data from a variety of sources to facilitate gamification of employee contributions and incentivize employee engagement.

FIG. 8 is a screen shot that illustrates a graphical user interface of a dashboard that is usable for implementing a method for aggregating data from a variety of sources to facilitate gamification of employee contributions and incentivize employee engagement, according to an exemplary embodiment.

FIG. 9 is a screen shot that illustrates a graphical user interface of a user profile that is usable for implementing a method for aggregating data from a variety of sources to facilitate gamification of employee contributions and incentivize employee engagement, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

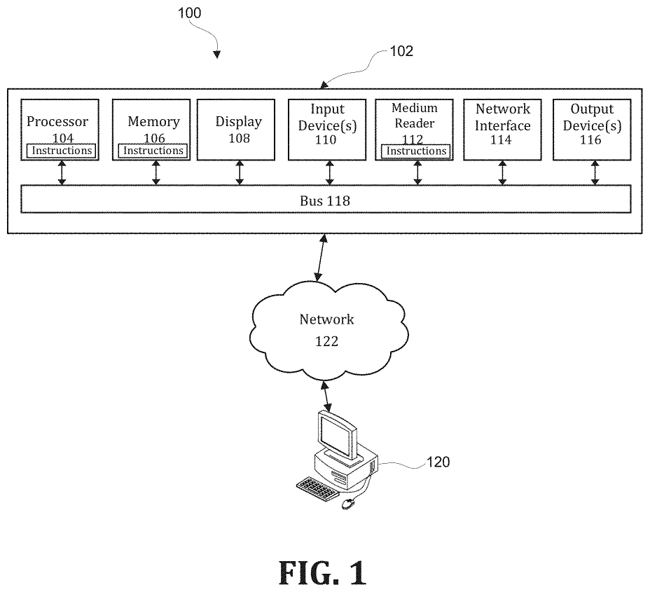

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for aggregating data from a variety of sources to facilitate gamification of employee contributions and incentivize employee engagement.

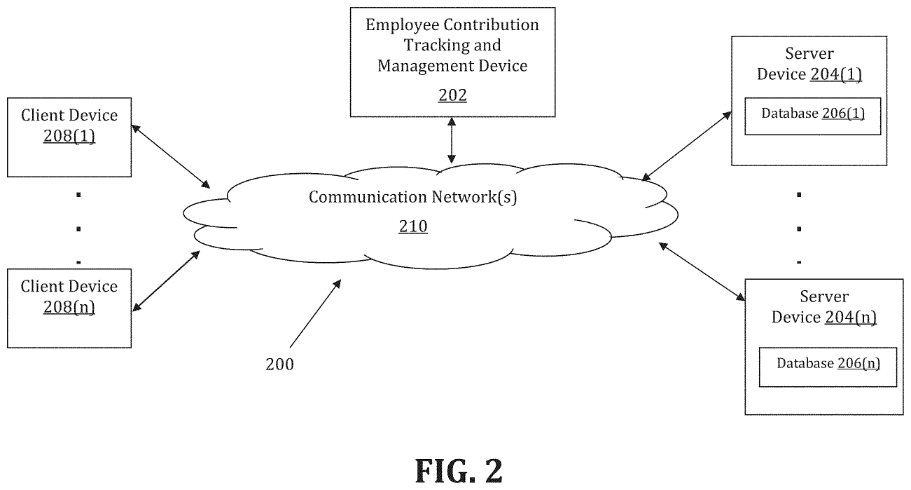

Referring to FIG. 2, a schematic of an exemplary network environment 200 for implementing a method for aggregating data from a variety of sources to facilitate gamification of employee contributions and incentivize employee engagement is illustrated. In an exemplary embodiment, the method is executable on any networked computer platform, such as, for example, a personal computer (PC).

The method for aggregating data from a variety of sources to facilitate gamification of employee contributions and incentivize employee engagement may be implemented by an Employee Contribution Tracking and Management (ECTM) device 202. The ECTM device 202 may be the same or similar to the computer system 102 as described with respect to FIG. 1. The ECTM device 202 may store one or more applications that can include executable instructions that, when executed by the ECTM device 202, cause the ECTM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ECTM device 202 itself, may be located in virtual server(s) running in a cloud-based computing environment rather than being tied to one or more specific physical network computing devices. Also, the application(s) may be running in one or more virtual machines (VMs) executing on the ECTM device 202. Additionally, in one or more embodiments of this technology, virtual machine(s) running on the ECTM device 202 may be managed or supervised by a hypervisor.

In the network environment 200 of FIG. 2, the ECTM device 202 is coupled to a plurality of server devices 204(1)-204(n) that hosts a plurality of databases 206(1)-206(n), and also to a plurality of client devices 208(1)-208(n) via communication network(s) 210. A communication interface of the ECTM device 202, such as the network interface 114 of the computer system 102 of FIG. 1, operatively couples and communicates between the ECTM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ECTM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ECTM devices that efficiently implement a method for aggregating data from a variety of sources to facilitate gamification of employee contributions and incentivize employee engagement.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ECTM device 202 may be a standalone device or integrated with one or more other devices or apparatuses, such as one or more of the server devices 204(1)-204(n), for example. In one particular example, the ECTM device 202 may include or be hosted by one of the server devices 204(1)-204(n), and other arrangements are also possible. Moreover, one or more of the devices of the ECTM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ECTM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to raw data, structured data, employee contribution data, employee achievement data, employee engagement data, characteristic data, and user profile data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/peripheral approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ECTM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ECTM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ECTM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ECTM device 202, the server devices 204(1)-204(n), or the client devices 208(1)-208(n), for example, may be configured to operate as virtual instances on the same physical machine. In other words, one or more of the ECTM device 202, the server devices 204(1)-204(n), or the client devices 208(1)-208(n) may operate on the same physical device rather than as separate devices communicating through communication network(s) 210. Additionally, there may be more or fewer ECTM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

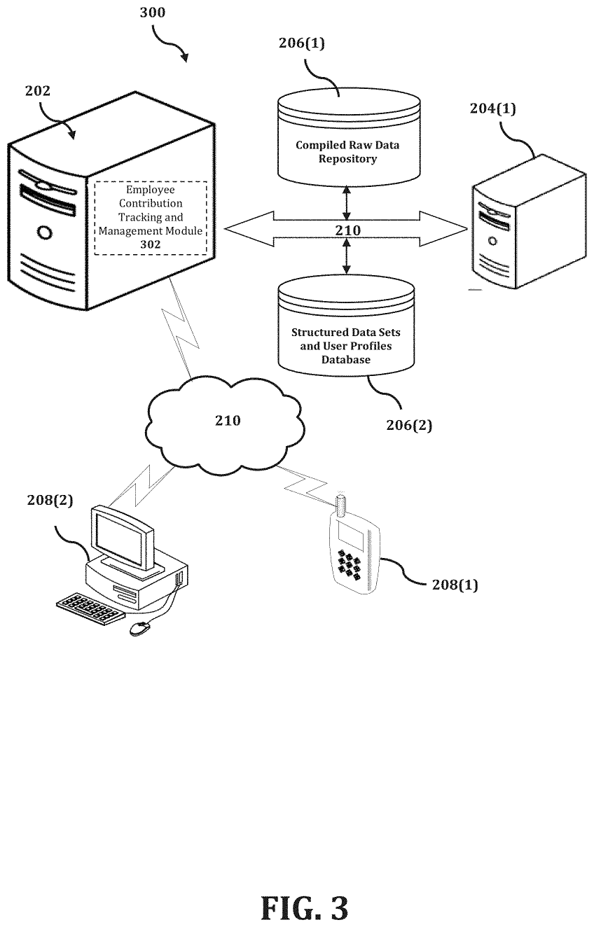

The ECTM device 202 is described and shown in FIG. 3 as including an employee contribution tracking and management module 302, although it may include other rules, policies, modules, databases, or applications, for example. As will be described below, the employee contribution tracking and management module 302 is configured to implement a method for aggregating data from a variety of sources to facilitate gamification of employee contributions and incentivize employee engagement.

An exemplary process 300 for implementing a mechanism for aggregating data from a variety of sources to facilitate gamification of employee contributions and incentivize employee engagement by utilizing the network environment of FIG. 2 is shown as being executed in FIG. 3. Specifically, a first client device 208(1) and a second client device 208(2) are illustrated as being in communication with ECTM device 202. In this regard, the first client device 208(1) and the second client device 208(2) may be “clients” of the ECTM device 202 and are described herein as such. Nevertheless, it is to be known and understood that the first client device 208(1) and/or the second client device 208(2) need not necessarily be “clients” of the ECTM device 202, or any entity described in association therewith herein. Any additional or alternative relationship may exist between either or both of the first client device 208(1) and the second client device 208(2) and the ECTM device 202, or no relationship may exist.

Further, ECTM device 202 is illustrated as being able to access a compiled raw data repository 206(1) and a structured data sets and user profiles database 206(2). The employee contribution tracking and management module 302 may be configured to access these databases for implementing a method for aggregating data from a variety of sources to facilitate gamification of employee contributions and incentivize employee engagement.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ECTM device 202 via broadband or cellular communication. Of course, these embodiments are merely exemplary and are not limiting or exhaustive.

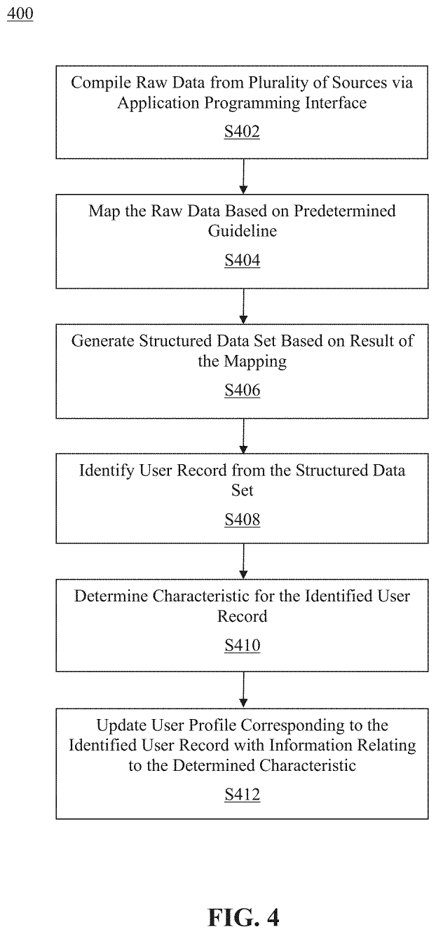

Upon being started, the employee contribution tracking and management module 302 executes a process for aggregating data from a variety of sources to facilitate gamification of employee contributions and incentivize employee engagement. An exemplary process for aggregating data from a variety of sources to facilitate gamification of employee contributions and incentivize employee engagement is generally indicated at flowchart 400 in FIG. 4.

In the process 400 of FIG. 4, at step S402, raw data may be compiled from a plurality of sources via an application programming interface. The raw data may include at least one from among employee contribution data, employee achievement data, and employee engagement data. In an exemplary embodiment, the raw data may be compiled from at least one from among a first-party data source as well as from a third-party data source. The raw data may be retrieved from an enterprise network environment such as, for example, a cloud network environment as well as an on-premise network environment. In another exemplary embodiment, the plurality of sources may include affinity groups that are formed around a shared interest and/or common goal such as, for example, diversity and inclusion, to which individuals formally or informally belong. The affinity groups may be organized based on social identity, shared characteristics, and/or life experiences.

In another exemplary embodiment, the raw data may be retrieved from each of the plurality of sources as individual data files as well as batch data files. For example, raw data for a particular employee may be retrieved from a source as a separate file as well as together in a batch file with other employees. In another exemplary embodiment, the batch data files may be assembled to include data of a particular group of employees based on a shared characteristic. For example, a particular batch data file may be assembled to include all data for employees belonging to a particular affinity group. In another exemplary embodiment, the raw data may be retrieved from the plurality of sources based on a predetermined schedule. For example, raw data may be retrieved from a particular data source once every twenty-four hours.

At step S404, the compiled raw data may be mapped based on a predetermined guideline. In an exemplary embodiment, a predetermined guideline may correspond to a data model. The data model may include an abstract model that organizes elements of data and standardizes the relationship between the various elements of the data. For example, the data model may specify that the data element representing an employee may be composed of a number of corresponding data sub-elements such as employee identifiers, employee job titles, and employee activities.

In another exemplary embodiment, the compiled raw data may be parsed to identify atomic units of data that has precise meaning and/or precise semantics such as, for example, data elements. The data elements in the compiled raw data may be mapped to data elements in a predetermined data model. For example, the compiled raw data may be parsed to identify employee identifiers, which are then mapped to a field for employee identifiers in the predetermined data model. In another exemplary embodiment, a validation action may be performed to ensure that expected data are mapped to fields in the predetermined data model. For example, for employee identifier fields that only accept numerical data, a validation action may return an error status when alphabetical data is mapped. Then, at step S406, a structured data set may be generated based on a result of the mapping. As will be appreciated by a person of ordinary skill in the art, the structured data set may include data in any data format such as, for example, a plain text format.

At step S408, a user record may be identified from the structured data set. The user record may include information that corresponds to a particular employee such as, for example, activities of a particular employee. The user record may be identified for the particular employee by using an identifier such as, an employee number that corresponds to the particular employee. In an exemplary embodiment, the activities may include employee contributions to initiatives such as, for example, diversity and inclusion initiatives. The employee may contribute to the initiatives in an official capacity as a representative of a business entity as well as in a personal capacity.

In another exemplary embodiment, several user records may be identified in the structured data set. For example, in a structured data set that is generated from a batch file, several user records may be identified. In another exemplary embodiment, the user record may be extracted from the structured data set after identification.

At step S410, a characteristic may be determined for each of the identified user records. In an exemplary embodiment, the characteristic may include at least one from among a first score that corresponds to an employee contribution, a second score that corresponds to an employee achievement, and a third score that corresponds to an employee engagement. The determined score may be based on predetermined values that have been assigned to employee activities. For example, an employee that participates in three qualifying events may earn a score of ten for employee engagement. In another exemplary embodiment, the characteristic may include a level of involvement in an activity. For example, an employee who participates in an activity on a weekly basis may earn a high level of involvement. As will be appreciated by a person of ordinary skill in the art, the characteristic may include any number and any combination of scores and levels.

In another exemplary embodiment, a visual representation such as, for example, a badge may be associated with the determined characteristic. For example, an employee may earn a badge for a corresponding activity based on the determined characteristic. In another exemplary embodiment, gamification elements based on the determined characteristic may be utilized to incentivize and encourage employee engagement. The gamification elements may include leaderboards, performance graphs, and unlockable avatars.

In another exemplary embodiment, rewards may be distributed based on the determined characteristic to incentivize and encourage employee engagement. The rewards may relate to an item of value that is given in recognition of an employee action. In another exemplary embodiment, the value of the rewards may correspond to at least one from among an intrinsic value, an extrinsic value, a functional value, a monetary value, a social value, and a psychological value.

At step S412, a user profile that corresponds to the identified user record may be updated with information relating to the determined characteristic. The user profile may include at least from among a social media profile that is accessible via a social media platform and an employee profile that is accessible via an enterprise communication platform. In an exemplary embodiment, the user profile may be uniquely associated with an employee and display information for that employee via a graphical user interface. For example, the user profile may include information such as a name, a job title, and contact data for the employee. In another exemplary embodiment, the user profile may display graphical elements that visually represent employee information. For example, the graphical elements may include dashboards that incorporate graphs for visualizing employee contribution scores.

In another exemplary embodiment, a graphical element may be generated for the determined characteristic. The graphical element may include a visual representation of the characteristic that is configured to receive an input. For example, a user may hover over a graphical element to get more information about a subject matter that is represented by the graphical element. In another exemplary embodiment, the graphical element may be displayed on a corresponding user profile via a graphical user interface.

In another exemplary embodiment, the visual representation of the characteristic may include at least one from among a badge, a performance graph, and a leaderboard. For example, an employee may earn a badge that is displayable on the user profile to indicate an employee achievement. In another exemplary embodiment, the graphical element may be generated when the corresponding characteristic satisfies a predetermined threshold. For example, when an employee has earned a score of one hundred in an employee achievement category, the employee may earn an employee achievement badge.

In another exemplary embodiment, updated characteristics may be identified for each of the identified user records. The updated characteristics may be identified in newly compiled raw data consistent with present disclosures. In another exemplary embodiment, a comparative difference between the updated characteristics and the corresponding originally determined characteristic may be determined. For example, the comparative difference may correspond to a score difference when the updated characteristics correspond to an employee engagement score. Then, the graphical element may be regenerated based on the comparative difference. The regenerated graphical element may illustrate the comparative difference.

In another exemplary embodiment, the illustration of the comparative difference may include at least one from among an enlargement of the graphical element for a positive change and a diminution of the graphical element for a negative change. For example, when the graphical element is visually represented as a tree, the tree may grow larger in response to the positive change and/or become smaller in response to the negative change. In another exemplary embodiment, the illustration of the comparative difference may include the addition of secondary graphical elements that visually represents the positive change and/or the negative change. For example, when the graphical element is visually represented as a tree, the tree may grow additional leaves in response to the positive change and/or lose leaves in response to the negative change.

In another exemplary embodiment, errors may be automatically detected during operation of the claimed invention. The errors may be related to a corruption of at least one from among the structured data sets and the user records. In another exemplary embodiment, a recovery action may be automatically initiated for each of the detected errors. The recovery action may relate to replacement of corrupted data with corresponding historical data.

In another exemplary embodiment, the structured data sets and the user records may be automatically persisted periodically to facilitate data resiliency and disaster recovery. The persisted structured data sets and the persisted user records may be used to replace corresponding corrupted data when the errors are detected. In another exemplary embodiment, the detected errors and the corresponding recovery action may be documented according to a predetermined policy such as, for example, a software documentation policy. A log may be automatically generated to document information that relates to the detected errors and the corresponding recovery action.

In another exemplary embodiment, a request to generate a report such as, for example, an administrative summary report and an individual employee development report may be received via the graphical user interface. The request may include employee specific information such as, for example, an identifier for a particular employee, the type of employee activities, and a time period. In another exemplary embodiment, the request may include specified formatting requirements such as, for example, an output file format and a visual presentation format. Then, the report may be generated in response to the request.

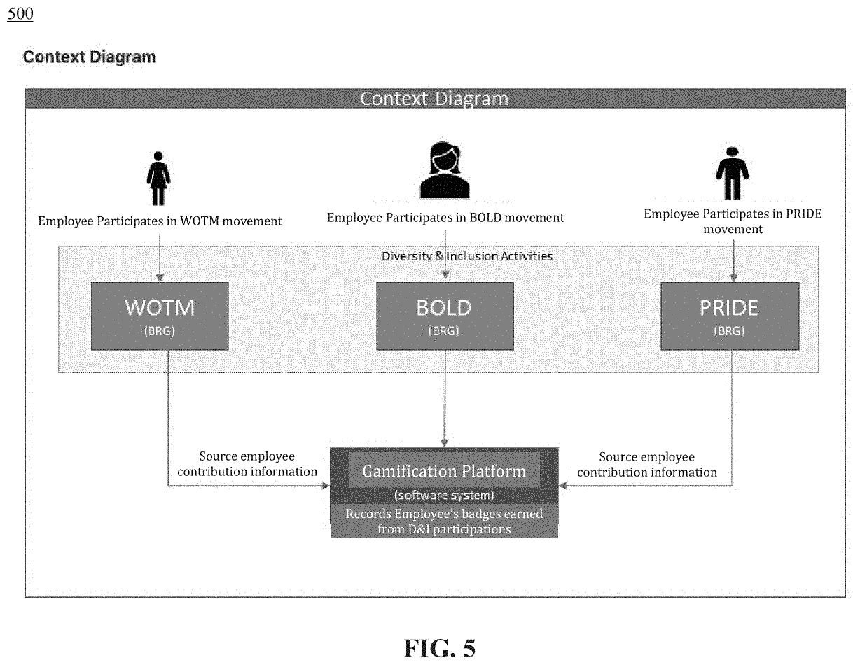

FIG. 5 is a context diagram 500 of an exemplary process for implementing a method for aggregating data from a variety of sources to facilitate gamification of employee contributions and incentivize employee engagement. As illustrated in FIG. 5, employees may participate in activities such as, for example, diversity and inclusion activities from a variety of different movements. The movements may operate independently and use different data schemas. Consistent with disclosures in the present application, the gamification platform may aggregate the activities data from the different data schemas, apply gamification logic to the aggregated data, and display a result of the gamification logic on a user profile to encourage employee involvement.

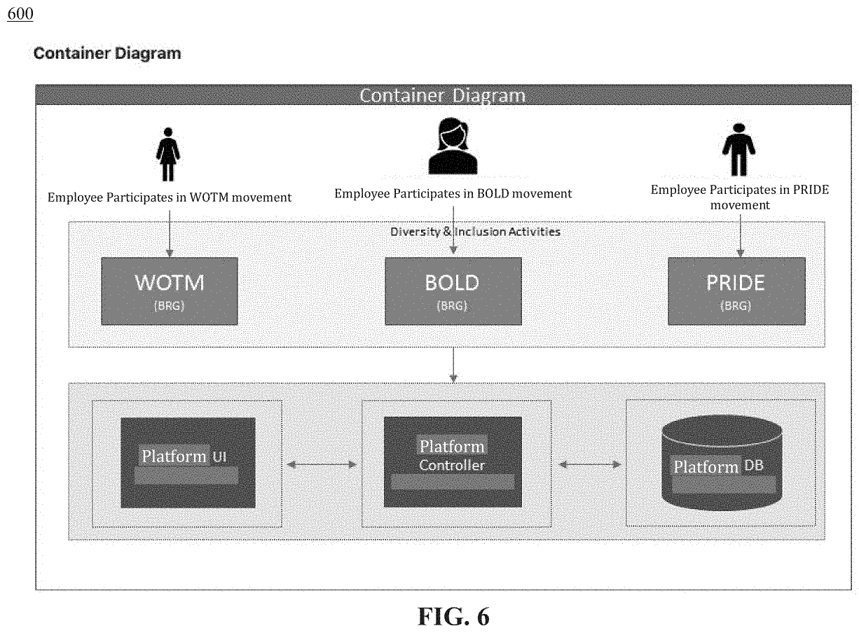

FIG. 6 is a container diagram 600 of an exemplary process for implementing a method for aggregating data from a variety of sources to facilitate gamification of employee contributions and incentivize employee engagement. As illustrated in FIG. 6, employees may participate in activities such as, for example, diversity and inclusion activities from a variety of different movements. The movements may operate independently and use different data schemas. Consistent with disclosures in the present application, the gamification platform may aggregate the activities data from the different data schemas, apply gamification logic to the aggregated data, and display a result of the gamification logic on a user profile to encourage employee involvement. The gamification platform may utilize a platform controller to access a networked platform database as well as to push employee information to a platform user interface (UI).

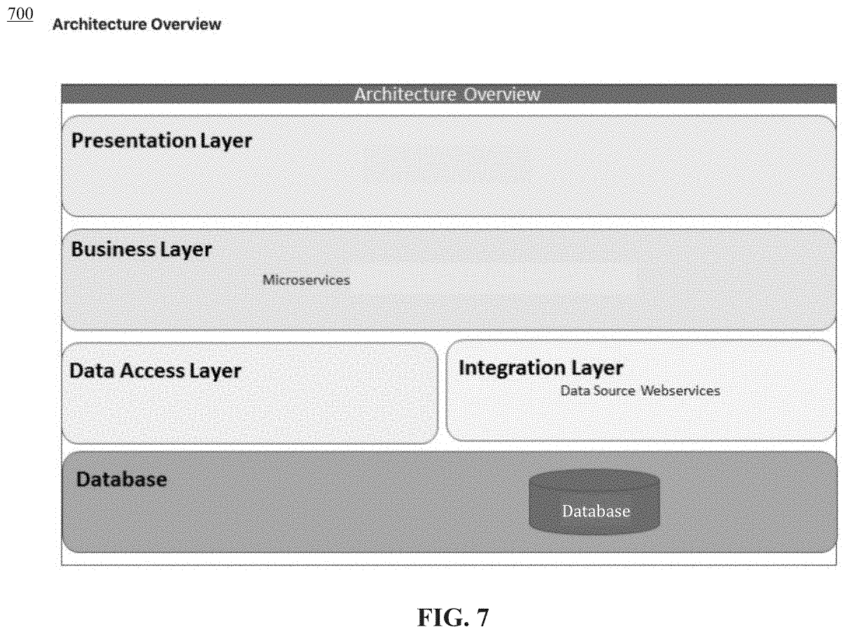

FIG. 7 is an overview diagram 700 of an exemplary architecture for implementing a method for aggregating data from a variety of sources to facilitate gamification of employee contributions and incentivize employee engagement. As illustrated in FIG. 7, the gamification platform may include a presentation layer, a business layer, a data access layer, an integration layer, and a database layer. The presentation layer may retrieve processed employee information from the business layer for display via a graphical user interface. The business layer may utilize microservices to access employee data in the database layer via the data access layer and the integration layer.

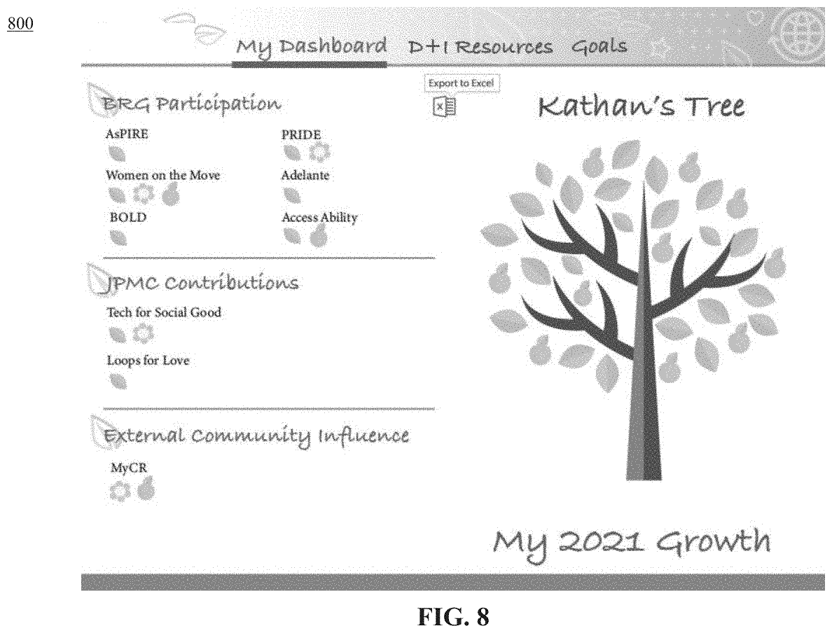

FIG. 8 is a screen shot 800 that illustrates a graphical user interface of a dashboard that is usable for implementing a method for aggregating data from a variety of sources to facilitate gamification of employee contributions and incentivize employee engagement, according to an exemplary embodiment. As illustrated in FIG. 8, the dashboard may include employee participation information, employee contribution information, and external community influence information. In an exemplary embodiment, the dashboard may display graphical elements such as, for example, badges, leaves, and flowers to visually represent achievements. For example, as employee achievement increases, the tree, which is a visual representation of the achievements, grows and has more leaves. In another exemplary embodiment, the graphical elements on the dashboard may also be configured to receive an input. For example, a user may hover over a particular leaf to view information of a corresponding achievement.

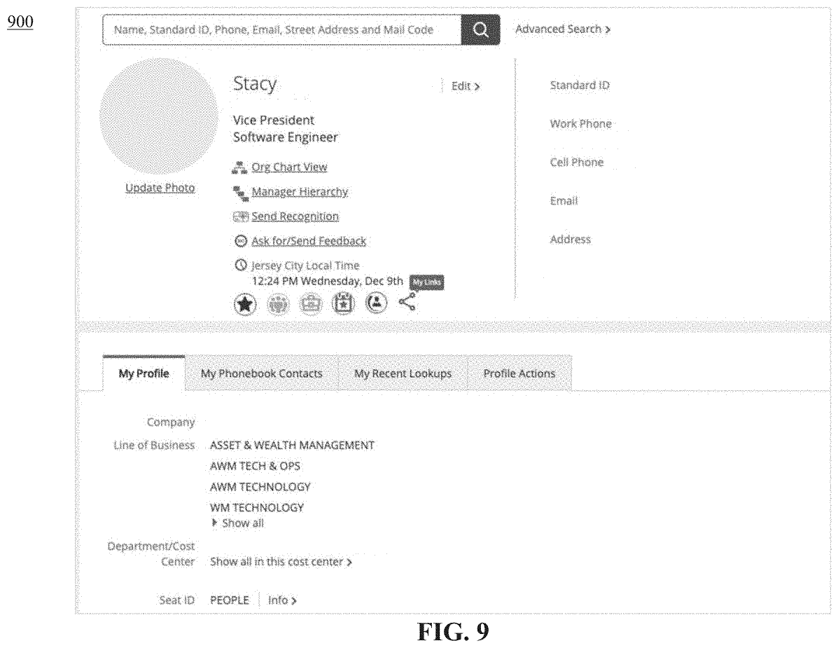

FIG. 9 is a screen shot 900 that illustrates a graphical user interface of a user profile that is usable for implementing a method for aggregating data from a variety of sources to facilitate gamification of employee contributions and incentivize employee engagement, according to an exemplary embodiment. As illustrated in FIG. 9, the user profile of an employee may include employee information such as, for example, identification information, status information, and contact information. The identification information of the employee may include a name, an identification number, and an image. The status information of the employee may include a job title, a line of business, as well as a date and time that the employee was last active. The contact information may include a work phone number, a cell phone number, and an email address.

Accordingly, with this technology, an optimized process for aggregating data from a variety of sources to facilitate gamification of employee contributions and incentivize employee engagement is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for aggregating data to facilitate gamification of employee contributions, the method being implemented by at least one processor, the method comprising:
compiling, by the at least one processor via an application programming interface, raw data from at least one source, the raw data including at least one from among employee contribution data, employee achievement data, and employee engagement data;
mapping, by the at least one processor, the compiled raw data based on at least one predetermined guideline;
generating, by the at least one processor, at least one structured data set based on a result of the mapping;
identifying, by the at least one processor, at least one user record from the at least one structured data set;
determining, by the at least one processor, at least one characteristic for each of the at least one identified user record; and
updating, by the at least one processor, a user profile that corresponds to the identified at least one user record with information relating to the determined at least one characteristic.

2. The method of claim 1, wherein the at least one characteristic includes at least one from among a first score that corresponds to an employee contribution, a second score that corresponds to an employee achievement, and a third score that corresponds to an employee engagement.

3. The method of claim 1, wherein the user profile includes at least one from among a social media profile that is accessible via a social media platform and an employee profile that is accessible via an enterprise communication platform.

4. The method of claim 1, further comprising:
generating, by the at least one processor, at least one graphical element for each of the at least one characteristic, the at least one graphical element including a visual representation of the at least one characteristic that is configured to receive an input; and
displaying, by the at least one processor via a graphical user interface, the user profile together with the corresponding at least one graphical element.

5. The method of claim 4, wherein the at least one graphical element is generated when the corresponding at least one characteristic satisfies at least one predetermined threshold.

6. The method of claim 4, wherein the visual representation includes at least one from among a badge, a performance graph, and a leaderboard.

7. The method of claim 4, further comprising:
identifying, by the at least one processor, at least one updated characteristic for each of the at least one identified user record;
determining, by the at least one processor, a comparative difference between the at least one updated characteristic and the at least one characteristic; and
regenerating, by the at least one processor, the at least one graphical element based on the comparative difference, the regenerated at least one graphical element illustrating the comparative difference.

8. The method of claim 7, wherein the illustration of the comparative difference includes at least one from among an enlargement of the at least one graphical element for a positive change and diminution of the at least one graphical element for a negative change.

9. The method of claim 1, further comprising:
detecting, by the at least one processor, at least one error, the error relating to a corruption of at least one from among the at least one structured data set and the at least one user record;
automatically initiating, by the at least one processor, at least one recovery action for the at least one error, the at least one recovery action relating to replacement of corrupted data with corresponding historical data; and
documenting, by the at least one processor, the at least one error and the corresponding at least one recovery action.

10. A computing device configured to implement an execution of a method for aggregating data to facilitate gamification of employee contributions, the computing device comprising:
a processor;
a memory; and
a communication interface coupled to each of the processor and the memory,
wherein the processor is configured to:
compile, via an application programming interface, raw data from at least one source, the raw data including at least one from among employee contribution data, employee achievement data, and employee engagement data;
map the compiled raw data based on at least one predetermined guideline;
generate at least one structured data set based on a result of the mapping;
identify at least one user record from the at least one structured data set;
determine at least one characteristic for each of the at least one identified user record; and
update a user profile that corresponds to the identified at least one user record with information relating to the determined at least one characteristic.

11. The computing device of claim 10, wherein the at least one characteristic includes at least one from among a first score that corresponds to an employee contribution, a second score that corresponds to an employee achievement, and a third score that corresponds to an employee engagement.

12. The computing device of claim 10, wherein the user profile includes at least one from among a social media profile that is accessible via a social media platform and an employee profile that is accessible via an enterprise communication platform.

13. The computing device of claim 10, wherein the processor is further configured to:
generate at least one graphical element for each of the at least one characteristic, the at least one graphical element including a visual representation of the at least one characteristic that is configured to receive an input; and
display, via a graphical user interface, the user profile together with the corresponding at least one graphical element.

14. The computing device of claim 13, wherein the processor is further configured to generate the at least one graphical element when the corresponding at least one characteristic satisfies at least one predetermined threshold.

15. The computing device of claim 13, wherein the visual representation includes at least one from among a badge, a performance graph, and a leaderboard.

16. The computing device of claim 13, wherein the processor is further configured to:
identify at least one updated characteristic for each of the at least one identified user record;
determine a comparative difference between the at least one updated characteristic and the at least one characteristic; and
regenerate the at least one graphical element based on the comparative difference, the regenerated at least one graphical element illustrating the comparative difference.

17. The computing device of claim 16, wherein the illustration of the comparative difference includes at least one from among an enlargement of the at least one graphical element for a positive change and diminution of the at least one graphical element for a negative change.

18. The computing device of claim 10, wherein the processor is further configured to:
detect at least one error, the error relating to a corruption of at least one from among the at least one structured data set and the at least one user record;
automatically initiate at least one recovery action for the at least one error, the at least one recovery action relating to replacement of corrupted data with corresponding historical data; and
document the at least one error and the corresponding at least one recovery action.

19. A non-transitory computer readable storage medium storing instructions for aggregating data to facilitate gamification of employee contributions, the storage medium comprising executable code which, when executed by a processor, causes the processor to:
compile, via an application programming interface, raw data from at least one source, the raw data including at least one from among employee contribution data, employee achievement data, and employee engagement data;
map the compiled raw data based on at least one predetermined guideline;
generate at least one structured data set based on a result of the mapping;
identify at least one user record from the at least one structured data set;
determine at least one characteristic for each of the at least one identified user record; and
update a user profile that corresponds to the identified at least one user record with information relating to the determined at least one characteristic.

20. The storage medium of claim 19, wherein the at least one characteristic includes at least one from among a first score that corresponds to an employee contribution, a second score that corresponds to an employee achievement, and a third score that corresponds to an employee engagement.
